(19) United States
(12) Patent Application Publication
(10) Pub. No.: US 2026/0246962 A1
(43) Pub. Date: Aug. 20, 2026

(54) SUB-BLOCK BASED MOTION VECTOR REFINEMENT

(71) Applicant: GOOGLE LLC, Mountain View, CA (US)

(72) Inventors: Mohammed Golam Sarwer, San Jose, CA (US); Jianle Chen, San Jose, CA (US); Debargha Mukherjee, Cupertino, CA (US)

(21) Appl. No.: 19/471,914

(22) PCT Filed: Mar. 22, 2024
(86) PCT No.: PCT/US2024/021033

§ 371 Date: Oct. 2, 2025

Related U.S. Application Data
(60) Provisional application No. 63/456,582, filed on Apr. 3, 2023.

(51) Int. Cl. H04N 19/52; H04N 19/105; H04N 19/109; H04N 19/119; H04N 19/139; H04N 19/172; H04N 19/176; H04N 19/70

(52) U.S. Cl. CPC H04N 19/52; H04N 19/105; H04N 19/109; H04N 19/119; H04N 19/139; H04N 19/172; H04N 19/176; H04N 19/70

(57) ABSTRACT

Coding a current block using motion vector refinement is disclosed. A first initial motion vector and a first reference frame are obtained for the current block. A second initial motion vector and a second reference frame are obtained for the current block. An optimal motion vector refinement is identified for a sub-block of the current block. A first refined motion vector is obtained as a combination of the first initial motion vector and the optimal motion vector refinement. A first prediction block is obtained based on the first refined motion vector. A prediction block is obtained for the sub-block by combining the first prediction block and a second prediction block obtained using the second initial motion vector.

### CROSS REFERENCE TO RELATED APPLICATIONS

This application claims priority to and the benefit of U.S. Provisional Patent Application Ser. No. 63/456,582, filed Apr. 3, 2023, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to motion vector refinement at the sub-block level of a current block.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for coding a current block using motion vector refinement. The method includes obtaining a first initial motion vector and a first reference frame for the current block. The method also includes obtaining a second initial motion vector and a second reference frame for the current block. The method also includes identifying an optimal motion vector refinement for a sub-block of the current block. The method also includes obtaining a first refined motion vector as a combination of the first initial motion vector and the optimal motion vector refinement. The method also includes obtaining a first prediction block based on the first refined motion vector. The method also includes obtaining a prediction block for the sub-block by combining the first prediction block and a second prediction block obtained using the second initial motion vector. Other embodiments of this aspect include corresponding computer systems, apparatus, and computer programs recorded on one or more computer storage devices, each configured to perform the actions of the methods.

Implementations may include one or more of the following features. The method may include: obtaining a second refined motion vector as a combination of the second initial motion vector and the optimal motion vector refinement; and obtaining the second prediction block based on the second refined motion vector, where the second prediction block is obtained based on the second refined motion vector.

Identifying of the optimal motion vector refinement may include: searching within at least one search area around at least one of the first initial motion vector or the second initial motion vector to minimize a prediction error metric.

The optimal motion vector refinement can be identified based on a sum of absolute differences (sad) calculation between predicted and actual pixel values within the sub-block.

The method may include: coding a flag within a compressed bitstream indicating whether to use the motion vector refinement. The flag can be conditionally coded based on a compound inter-prediction mode of the current block, with specific modes automatically enabling or disabling the motion vector refinement without explicit signaling of the flag. The flag can be enabled if a size of the current block exceeds a predetermined threshold. The flag can be coded based on respective distances between a current frame that includes the current block and the first reference frame and the second reference frame.

The method may include coding within a compressed bitstream a syntax element specifying a motion vector refinement strategy indicating which of the first initial motion vector and the second initial motion vector are refined.

Combining the first prediction block and the second prediction block may include using a weighted average with weights determined based on respective temporal distances of the first reference frame and the second reference frame from a current frame that includes the current block.

The sub-blocks are of equal size that can be selected based on a size of the current block or based on a configuration parameter.

One general aspect includes another method. The method includes dividing a current block of video data into a plurality of non-overlapping sub-blocks. The method also includes for at least one of the sub-blocks, determining respective offset motion vectors (ΔMVs) by searching predefined areas around initial motion vectors associated with the current block. The method also includes obtaining refined motion vectors for at the least one of the sub-blocks by adjusting the initial motion vectors based on the respective offset motion vectors (ΔMVs). The method also includes generating a prediction for at least one of the sub-blocks using the refined motion vectors. The method also includes combining respective predictions of the sub-blocks to form a final prediction for the current block. Other embodiments of this aspect include corresponding computer systems, apparatus, and computer programs recorded on one or more computer storage devices, each configured to perform the actions of the methods.

Implementations may include one or more of the following features. The method where the predefined areas may include integer and sub-pixel positions. The respective offset motion vectors (ΔMVs) can be determined based on a similarity metric between predicted values of at least one of the sub-blocks and corresponding values in a reference frame. The current block may be coded using a compound mode, and the initial motion vectors may include respective motion vectors for two reference frames.

The method may include: signaling a flag within a compressed bitstream indicating whether sub-block based motion vector refinement is applied. The flag can be signaled at at least one of a sequence header, frame header, or current block level.

A size of the sub-blocks can be determined based on a size of the current block. The size of the sub-blocks can be determined based on a coding mode of the current block.

One general aspect includes another method. The method also includes receiving a compressed bitstream that includes initial motion vectors for a current block of video data. The method also includes partitioning the current block into a plurality of non-overlapping sub-blocks. The method also includes for each of the sub-blocks, identifying respective optimal offset motion vectors (ΔMVs) by evaluating a search area around at least one of the initial motion vectors. The method also includes adjusting the initial motion vectors based on the optimal offset motion vectors mv to obtain refined motion vectors. The method also includes decoding the sub-blocks based on the refined motion vectors. Other embodiments of this aspect include corresponding computer systems, apparatus, and computer programs recorded on one or more computer storage devices, each configured to perform the actions of the methods.

Implementations may include one or more of the following features. The method where the search area is centered on the at least one of the initial motion vectors and includes a predefined range in a horizontal direction and a vertical direction.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a diagram of motion vectors representing full and sub-pixel motion.

FIG. 7A illustrates an example of generating a group of motion vector candidates for a current block based on spatial neighbors of the current block.

FIG. 7B illustrates an example of generating a group of motion vector candidates for a current block based on temporal neighbors of the current block.

FIG. 7C illustrates an example of generating a group of motion vector candidates for a current block based on non-adjacent spatial candidates of the current block.

FIG. 8 is an illustration of compound inter-prediction.

FIG. 9 is a flowchart of an example of a technique for identifying offset motion vectors for sub-blocks of a current block.

FIG. 10 is an illustration of identifying optimal motion vectors for a sub-block of a current block.

FIG. 11 is an example of a technique for identifying an optimal offset MV for only one of two reference frames.

FIG. 12 is an example of a flowchart of a technique for coding a current block using motion vector refinement.

FIG. 13 is an example of a flowchart of a technique 1300 for coding a current block.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities is known as inter prediction or motion-compensated prediction (MCP). A prediction block of a current block (i.e., a block being coded) is generated by finding a corresponding block in a reference frame following a motion vector (MV). That is, inter prediction attempts to predict the pixel values of a block using a possibly displaced block or blocks from a temporally nearby frame (i.e., a reference frame) or frames. A temporally nearby frame is a frame that appears earlier or later in time in the video stream than the frame (i.e., the current frame) of the block being encoded (i.e., the current block). An MV used to generate a prediction block refers to (e.g., points to or is used in conjunction with) a frame (i.e., a reference frame) other than the current frame. An MV may be defined to represent a block or pixel offset between the reference frame and the corresponding block or pixels of the current frame.

MCP can be performed either from a single reference frame or from two reference frames. Inter prediction modes that perform motion compensation from two reference frames may be referred to as compound inter-prediction modes (or compound modes, for brevity). In compound modes, two MVs can be signaled to (or may be derived from a list of candidate MVs at) the decoder. For example, the motion vector(s) for a current block in MCP may be encoded into, and decoded from, a compressed bitstream. If both reference frames are, in display order, located on the same side from the current frame, the prediction mode may be referred to as a unidirectional prediction mode. If one of the reference frames is in the backward direction and another reference frame is in the forward direction in the display order, the compound mode may be referred to as bidirectional prediction mode.

A motion vector for a current block is described with respect to a co-located block in a reference frame. The motion vector describes an offset (i.e., a displacement) in the horizontal direction (i.e., MVₓ) and a displacement in the vertical direction (i.e., MV_{y}) from the co-located block in the reference frame. As such, an MV can be characterized as a 3-tuple (f, MVₓ, MV_{y}) where f is indicative of (e.g., is an index of) a reference frame, MVₓ is the offset in the horizontal direction from a collocated position of the reference frame, and MV_{y} is the offset in the vertical direction from the collocated position of the reference frame. As such, at least the offsets MVₓ and MV_{y} are written (i.e., encoded) into the compressed bitstream and read (i.e., decoded) from the encoded bitstream.

As is known, there is generally a need to construct a list of candidate MVs and to code an index of a reference MV (i.e., a selected MV) in the list of candidate MVs. That is, at the encoder, the list of candidate MVs may be constructed according to predetermined rules and an index of a selected MV candidate may be encoded in a compressed bitstream; and, at the decoder, the list of candidate MVs may be constructed (e.g., generated) according to the same predetermined rules and the index of the selected MV candidate may be decoded from the compressed bitstream. In some situations (such as based on the inter prediction mode), it may not be necessary for the encoder to encode an index of an MV; rather, the index of the selected MV may be inferred at the decoder. In either case, before decoding an inter-predicted block, at first a list of candidate MVs is generated (such as, amongst others, from neighboring blocks and collocated blocks). The list of candidate MVs contains a list of reference MVs of a current block.

To lower the rate cost of encoding the motion vectors, a motion vector may be encoded differentially. Namely, a predicted motion vector (PMV) may be selected as a reference motion vector, and only a difference (also called the motion vector difference (MVD)) between the motion vector (MV) of a current block and the reference motion vector is encoded into the bitstream. The reference (or predicted) motion vector may be a motion vector of one of the neighboring blocks, for example, and may be selected from the list of candidate MVs. Thus, MVD=MV-PMV. The neighboring blocks can include spatial neighboring blocks (i.e., blocks in the same current frame as the current block). The neighboring blocks can include temporal neighboring blocks (i.e., blocks in frames other than the current frame). An encoder codes the MVD in the compressed bitstream; the encoder may also code the PMV (i.e., an index thereof in the list of candidate MVs) in the compressed bitstream; and a decoder decodes the MVD from the compressed bitstream and adds it to the predicted (or reference) motion vector (PMV) to obtain the motion vector (MV) of a current block.

As alluded to above, coding an MV may include coding the horizontal offset (i.e., MVₓ) and coding the vertical offset (i.e., MV_{y}) of the MV or coding the horizontal offset (i.e., MVDₓ) and coding the vertical offset (i.e., MVD_{y}) of the MVD. When implemented by an encoder, “coding” means encoding in a compressed bitstream. When implemented by a decoder, “coding” means decoding from an compressed bitstream.

To reduce the number of bits required to code motion information (including motion vector information), and improve prediction accuracy, sub-block based motion vector refinement, which is a decoder-side motion-vector derivation (DMVD) technique, can be used to obtain, at the decoder, refined motion information for sub-blocks of a current block that is coded using a compound inter-prediction mode. The compound inter-prediction can be a unidirectional or a bidirectional inter-prediction mode. Initial MVs (i.e., MV₀ and MV₁) may be identified (e.g., selected) for the current block. The block can be partitioned into sub-blocks. Refined motion vectors can be obtained for the sub-blocks based on the initial MVs. Each of the sub-blocks is then encoded or decoded using its obtained refined motion vectors.

If a current block is coded as compound mode (e.g., bi-directional or uni-directional where at least one of two reference frames is a forward reference or a backward reference frame), motion vectors of the sub-blocks of the current block are refined before producing the final prediction. Sub-block based motion vector refinement includes dividing a current block into k non-overlapping sub-blocks. For each sub-block, optimal offset MVs (denoted ΔMV₀ and ΔMV₁) are derived. Refined MVs (denoted RefinedMV₀ and RefinedMV₁) for a sub-block are computed by adding the optimal offset MVs obtained for the sub-block with the initial MV, which may be signaled or derived from the list of candidate MVs. More specifically, one of the optimal offset MVs may be added to one of the initial motion vectors and subtracted from the other initial motion vector.

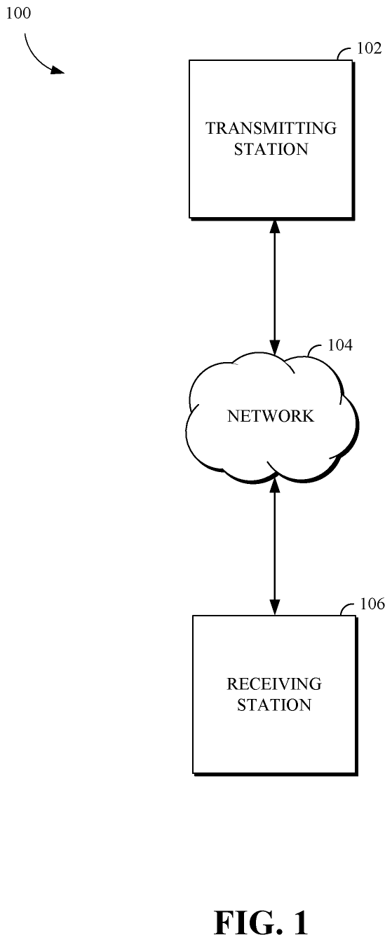

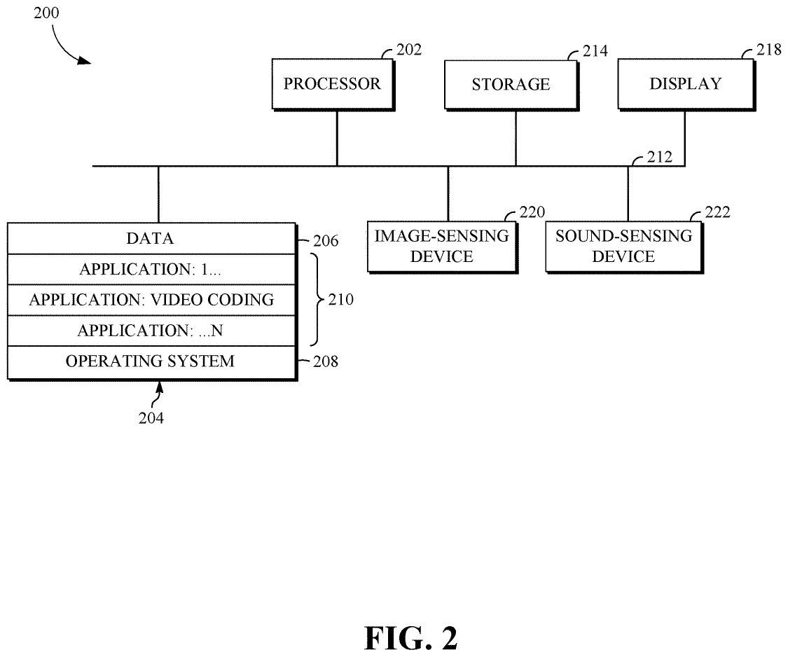

Further details of template matching using available peripheral pixels are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

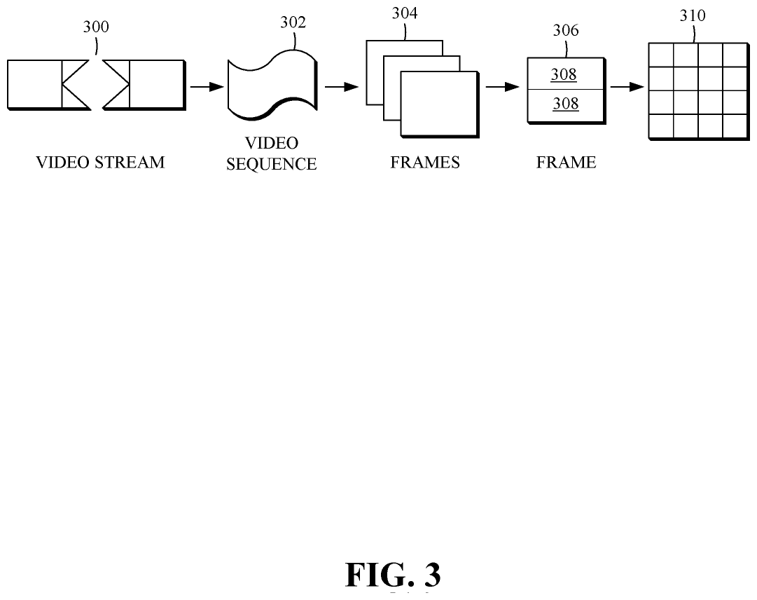

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

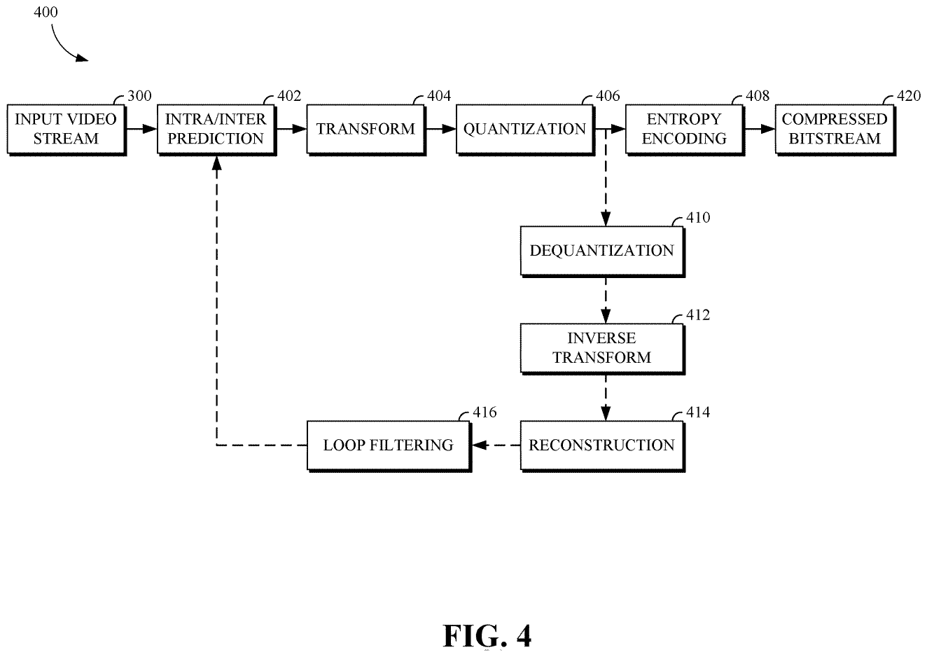

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

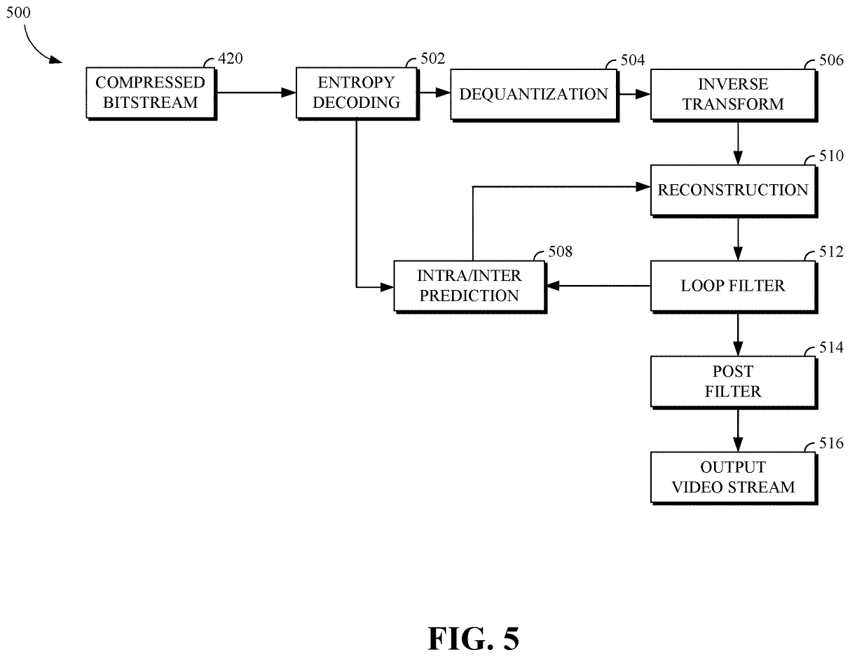

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

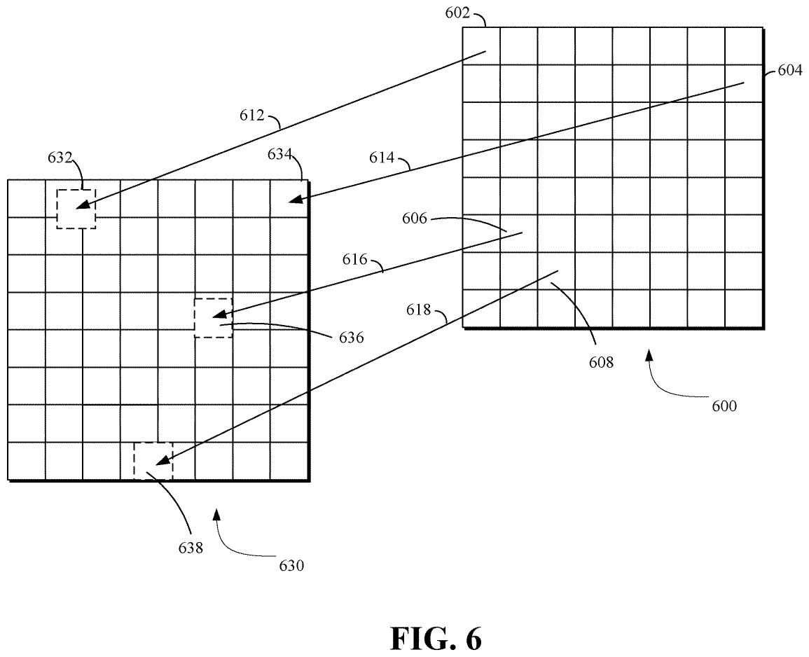

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 is a reference frame, also called the temporally adjacent frame, in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using two different reference frames), where pixels from each prediction are combined in some manner to form a prediction block.

As mentioned above, a list of candidate MVs may be generated according to predetermined rules. The predetermined rules for generating (e.g., deriving, or constructing and ordering) the list of candidate MVs and the number of candidates in the list may vary by codec. For example, in High Efficiency Video Coding (H.265), the list of candidate MVs can include up to 5 candidate MVs.

Codecs may populate the list of candidate MVs using different algorithms, techniques, or tools (collectively, tools). Each of the tools may produce a group of MVs that are added to the list of candidate MVs. For example, in Versatile Video Coding (H.266), the list of candidate MVs may be constructed using several modes, including intra-block copy (IBC) merge, block level merge, and sub-block level merge. The details of these modes are not necessary for the understanding of this disclosure. H.266 limits the number of candidate MVs obtained using IBC merge, block-level merge, and sub-block level merge, to 6 candidates, 6 candidates, and 5 candidates, respectively. Different codecs may use different techniques for generating lists of candidate MVs. Additionally, different modes of a codec may use different lists of candidate MVs. However, such nuances are not necessary for the understanding of this disclosure. As such, the disclosure merely assumes a use of a list of candidate MVs.

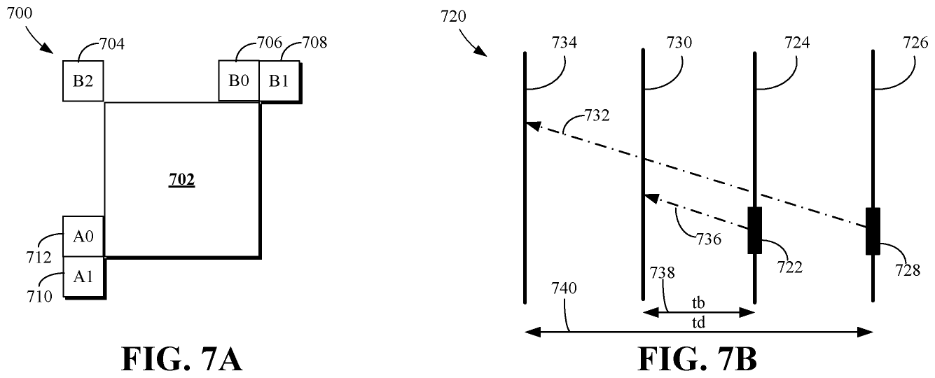

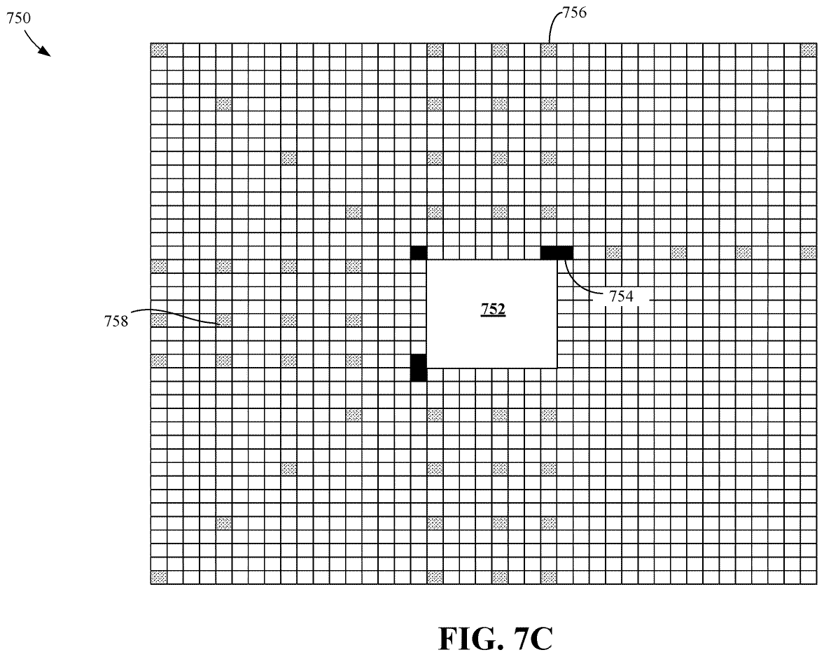

FIGS. 7A-7C illustrate examples of tools for generating groups of motion vectors. As mentioned above, a list of candidate MVs may be obtained using different tools. An encoder, such as the encoder 400 of FIG. 4, and a decoder, such as the decoder 500 of FIG. 5, may use the same tools for obtaining (e.g., populating, constructing, etc.) the same list of candidate MVs. The candidate MVs obtained using a tool are referred to herein as a group of candidate MVs. At least some of the tools described herein may be known or may be similar to or used by other codecs. However, the disclosure is not limited to or by any particular tools that can generate groups of MV candidates. The groups of motion vectors may be or may be combined to form a list of candidate MVs.

As mentioned above, merge candidates or candidate MVs may be derived using different tools. Some such tools are now described. Depending on the inter-prediction mode, different motion information may be coded in a compressed bitstream, such as the compressed bitstream 420 of FIG. 4 or 5. For example, if a block is coded using the MERGE mode, a reference frame index and a motion vector of the list of candidate MVs are set as the reference frame index and motion vector of the block. A merge candidate corresponding to a merge index (e.g., the index of the candidate in the list of candidate MVs) is selected from the merge candidate list and the motion information of the merge candidate is set as the motion information of the block. The merge index (e.g.,) the index of the candidate in the list of candidate MVs may be coded in the compressed bitstream. For example, if a motion vector is coded differentially, an MVP is selected from list of candidate MVs. The index of the MVP in the list of candidate MVs may be included in the compressed bitstream. The MVD may also be included (i.e., coded) in the compressed bitstream. Additionally, a reference frame index may also be included (i.e., coded) in the compressed bitstream.

FIG. 7A illustrates an example 700 of generating a group of motion vector candidates for a current block based on spatial neighbors of the current block. The example 700 may be referred to or may be known as generating or deriving spatial merge candidates. The spatial merge mode is limited to merging with spatially-located blocks in the same picture.

A current block 702 may be “merged” with one of its spatially available neighboring block(s) to form a “region.” FIG. 7A illustrates that spatially available neighboring blocks includes blocks 704-712 (i.e., blocks 704, 706, 708, 710, 712). As such, up to six MV candidates (i.e., corresponding to the MVs of the blocks 704-712) may be possible (i.e., added to the list of candidate motion vectors or the merge list). However, more or fewer spatially neighboring blocks may be considered. In an example, a maximum of four merge candidates may be selected from amongst candidate blocks 704-712.

All pixels within the merged region share the same motion parameters (e.g., the same MV(s) and reference frame(s)). Thus, there is no need to code and transmit motion parameters for each individual block of the region. Instead, for a region, only one set of motion parameters is encoded and transmitted from the encoder and received and decoded at the decoder. In an example, a flag (e.g., merge_flag) may be used to specify whether the current block is merged with an available neighboring block. Additionally, an index of the MV candidate in the list of MV candidates of the neighboring block with which the current block is merged.

FIG. 7B illustrates an example 720 of generating a group of motion vector candidates for a current block based on temporal neighbors of the current block. The example 720 may be referred to or may be known as generating or deriving temporal merge candidates or as a temporal merge mode. In an example, the temporal merge mode may be limited to merging with temporally co-located blocks in neighboring frames. In another example, blocks in other frames other than a co-located block may also be used.

A co-located block may be a block that is in a similar position as the current block in another frame. Any number of co-located blocks can be used. That is, the respective co-located blocks in any number of previously coded pictures can be used. In an example, the respective co-located blocks in all of the previously coded frames of the same group of pictures (GOP) as the frame of the current block are used. Motion parameters of the current block may be derived from temporally-located blocks and used in the temporal merge.

The example 720 illustrates that a current block 722 of a current frame 724 is being coded. A frame 726 is a previously coded frame, a block 728 is a co-located block in the frame 726 to the current block 722, and a frame 730 is a reference frame for the current frame. A motion vector 732 is a the motion vector of the block 728. The frame 726, which includes the co-located block 728, may be referred to as the “collocated picture” or collocated frame.” The motion vector 732 points to a reference frame 734. The reference frame 734, which is the reference frame of the collocated picture, may be referred to as the “collocated reference picture” or the “collocated reference frame.” As such, a motion vector 736, which may be a scaled version of the motion vector 732 can be used as a candidate MV for the current block 722. The motion vector 732 can be scaled by a distance 738 (denoted tb) and a distance 740 (denoted td). The distance can be the picture order count (POC) or the display order of the frames. As such, in an example, tb can be defined as the POC difference between the reference frame (i.e., the frame 730) of the current frame (i.e., the current frame 724) and the current frame; and td is defined to be the POC difference between the reference frame (i.e., the reference frame 734) of the co-located frame (i.e., the frame 726) and the co-located frame (i.e., the frame 726).

FIG. 7C illustrates an example 750 of generating a group of motion vector candidates for a current block 752 based on non-adjacent spatial candidates of the current block. A current block 752 illustrates a largest coding unit (which may be further divided into sub-blocks), which may be divided into sub-blocks and where at least some of the sub-blocks may be inter predicted. Blocks that are filled with the black color, such as a block 754, illustrate the neighboring blocks described with respect to FIG. 7A. Blocks filled with the dotted pattern, such as blocks 756, 758 are used for obtaining the group of motion vector candidates for the current block 752 based on non-adjacent spatial candidates.

An order of evaluation of the non-adjacent blocks may be predefined. However, for brevity, the order is not illustrated in FIG. 7C and is not described herein. The group of candidate MVs based on non-adjacent spatial candidates may include 5, 10, fewer, or more MV candidates.

Another example (not illustrated) of generating a group of MV candidates (or merge candidates) for a current block can be history based MV derivation, which may be referred to as history based MV prediction (HMVP) mode.

In the HMVP mode, the motion information of a previously coded block can be stored in a table and used as a candidate MV for a current block. The table with multiple HMVP candidates can be maintained during the encoding/decoding process. The table can be reset (emptied) when a new row of largest coding units (which may be referred to as a superblock or a macroblock) is encountered.

In an example, The HMVP table size may be set to 6, which indicates that up to 6 HMVP candidate MVs may be added to the table. When inserting a new candidate MV into the table, a constrained first-in-first-out (FIFO) rule may be utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table can be checked in order and inserted to the candidate MV list after the temporal merge candidate. A codec may apply redundancy check on the HMVP candidates to the spatial or temporal merge candidate(s).

Yet another example (not illustrated) of generating a group of candidate MVs for a current block can be based on averaging predefined pairs of MV candidates in the already generated groups of MV candidates of the list of MV candidates.

Pairwise average MV candidates can be generated by averaging predefined pairs of candidates in the existing merge candidate list, using motion vectors of already generated groups of MVs. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors can be averaged even when they point to different reference frames, and the reference frame for the average MV can be set to be the same reference frame as that of p0Cand; if only one MV is available, use the one directly; if no motion vector is available, keep this list invalid. Also, if the half-pel interpolation filter indices of p0Cand and p1Cand are different, the half-pel interpolation filter is set to 0.

In yet another example (not illustrated), a group of zero MVs may be generated. A current reference frame of a current block may use one of N reference frames. A zero MV is a motion vector with displacement (0, 0). The group of zero MVs may include 0 or more zero MVs with respect to at least some of the N reference frames.

It is again noted that the tools described herein for generating groups of candidate MVs does not limit the disclosure in any way and that different codecs may implement such tools differently or may include fewer or more tools for generating candidate MVs or merge candidates.

To summarize, a conventional codec may generate a list of candidate MVs using different tools. Each tool may be used to generate a respective group of candidate MVs. Each group of candidate MVs may include one or more candidate MVs. The candidate MVs of the groups are appended to the list of candidate MVs in a predefined order. The list of candidate MVs has a finite size and the different tools are used until the list is full. For example, the list of candidate MVs may be of size 6, 10, 15, or some other size. For example, spatial merge candidates may be first be added to the list of candidate MVs. If the list is not full, then at least some of temporal merge candidates may be added. If the list is still not full, then at least some of the HMVP candidates may be added. If the list is still not full, then at least some of the pairwise average MV candidates may be added. If the list is still not full, then zero MVs may be added. The size of the list of candidate MVs may be signaled in the compressed bitstream and the maximum allowed size of the merge list may be pre-defined. For each coding unit, an index of the best merge candidate may be encoded using truncated unary binarization. In an example, the first bin of the merge index may be coded with context and bypass coding may be used for other bins.

Additionally, conventional codecs may perform redundancy checks so that a same motion vector is not added more than once at least in the same group of candidate MVs. To illustrate, after the candidate at position A1 of FIG. 7A (i.e., the block 710) is added, the addition of the remaining candidates may be subject to a redundancy check to ensure that candidates with the same motion information are excluded from the list. As another illustration, redundancy checks may be applied on the HMVP candidates with the spatial or temporal merge candidates. In some codecs, and to reduce the number of redundancy check operations, simplifications may be introduced, such as, once the total number of available merge candidates reaches the maximally allowed merge candidates minus 1, the merge candidate list construction process from HMVP is terminated.

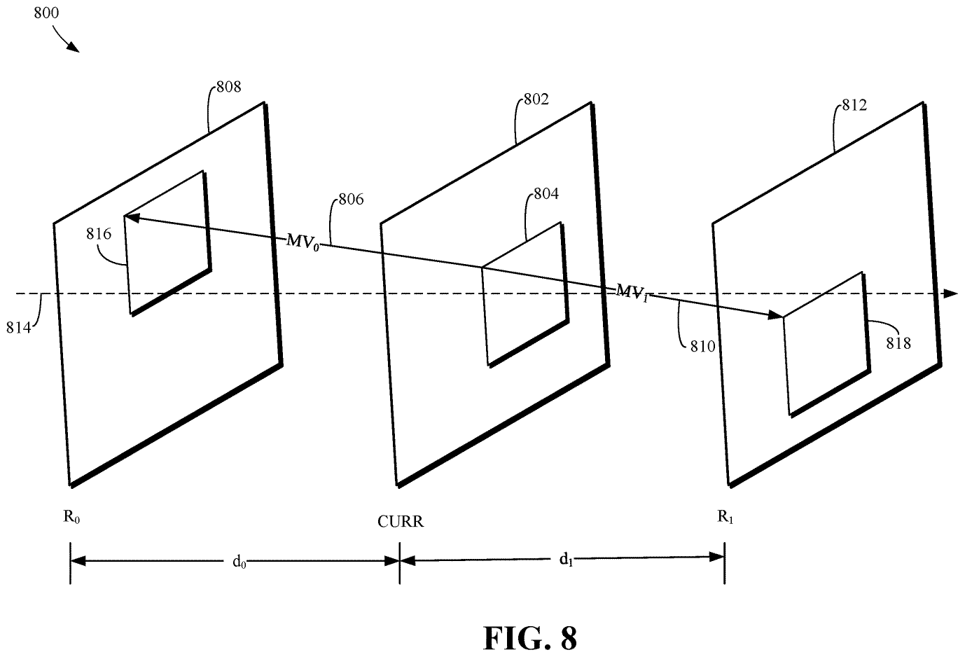

FIG. 8 is an illustration 800 of compound inter-prediction. The illustration 800 includes a current frame 802 that includes a current block 804 to be coded (i.e., encoded or decoded) using a first MV 806 (i.e., MV₀) that refers (i.e., points) to a first reference frame 808 (i.e., R₀) and a second MV 810 (i.e., MV₁) that refers to a second reference frame 812 (i.e., R₁). A line 814 illustrates the display order, in time, of the frames. As such, the illustration 800 is an example of a bi-directional prediction since the current frame 802 is between the first reference frame 808 and the second reference frame 812 in the display order. However the disclosure herein is not limited to bi-directional prediction and the techniques described herein can also be used with (e.g., adapted to) uni-directional prediction.

The distance, in display order, between the first reference frame 808 and the current frame 802 is denoted d₀; and the distance, in display order, between the current frame 802 and the second reference frame 812 is denoted d₁. While not specifically shown in FIG. 8, each of the first MV 806 and the second MV 810 includes a horizontal and vertical offset. Thus, MV_{0,x} and MV_{0,y} can denote, respectively, the horizontal and the vertical components of the first MV 806; and MV_{1,x} and MV_{1,y} can denote, respectively, the horizontal and the vertical components of the second MV 810. The first MV 806 and the first reference frame 808 can be used to obtain a first prediction block 816 (denoted P₀) for the current block 804; and the second MV 810 and the second reference frame 812 can be used to obtain a second prediction block 818 (denoted P₁) for the current block 804. A final prediction block for the current block 804 can be obtained as a combination (e.g., a pixel-wise weighted average) of the first prediction block 816 and the second prediction block 818.

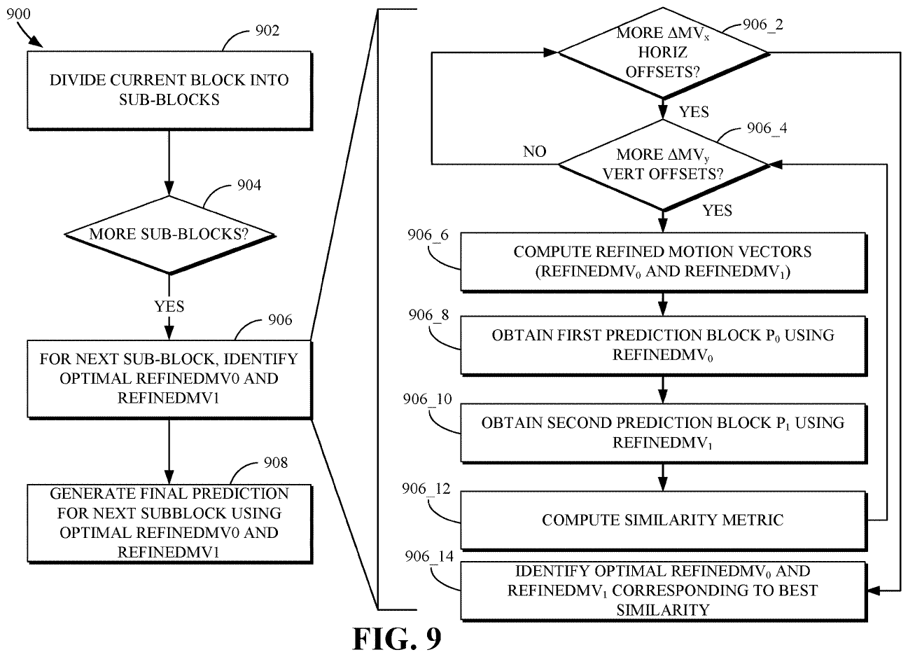

FIG. 9 is a flowchart of an example of a technique 900 for identifying offset motion vectors for sub-blocks of a current block. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 900. The technique 900 may be implemented in whole or in part in the intra/inter prediction stage 402 of the encoder 400 of FIG. 4 and/or the intra/inter prediction stage 508 of the decoder 500 of FIG. 5. The technique 900 can be implemented using specialized hardware or firmware. Multiple processors, memories, or both, may be used.

While not specifically shown in FIG. 9, initial motion vectors (i.e., a first motion vector MV₀ and a second motion vector MV₁) are assumed to have been identified for the current block. In an example, and when implemented by a decoder, the initial motion vectors MV₀ and MV₁ can be identified based on one or more syntax elements decoded from a compressed bitstream. The disclosure is not limited to or by any particular way of identifying the initial motion vectors MV₀ and MV₁.

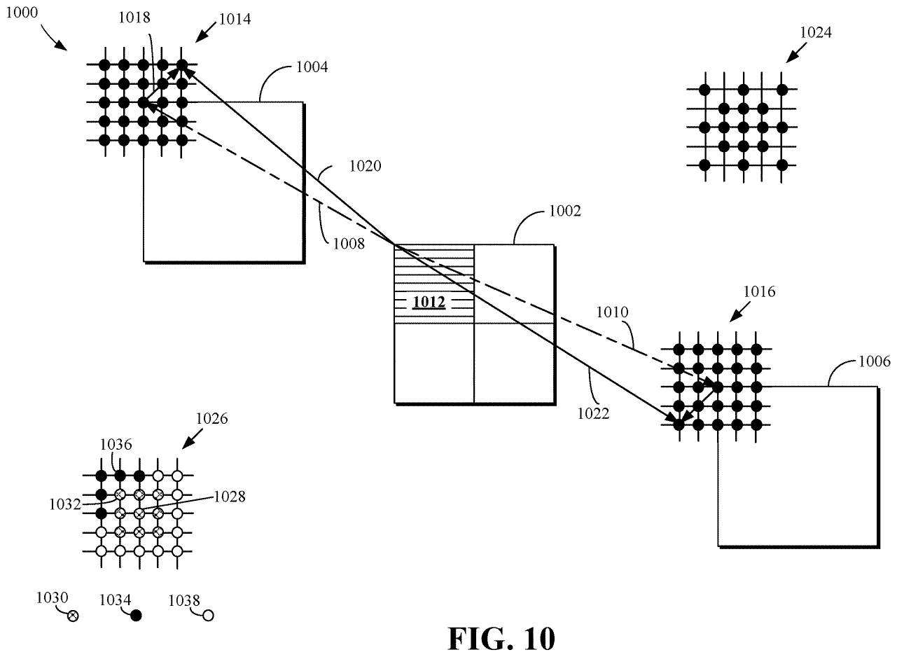

The technique 900 is further described with reference to FIG. 10. FIG. 10 is an illustration 1000 of identifying optimal motion vectors for a sub-block of a current block. The illustration 1000 includes a current block 1002 of a current frame (not shown). The current block 1002 can be the current block 804 of FIG. 8. The current block 1002 is illustrated as being predicted using a compound inter-prediction mode. As such, a first reference block 1004 can be the first prediction block 816 of FIG. 8; a second reference block 1006 can be the second prediction block 818 of FIG. 8; an initial MV 1008 can be the first MV 806 of FIG. 8; and an initial MV 1010 can be the second MV 810 of FIG. 8.

At 902, the current block is divided into sub-blocks. The current block 1002 of FIG. 10 is shown as being divided into four non-overlapping sub-blocks, which include a sub-block 1012. In an example, the current block can be divided into k (where k is a positive integer) number of non-overlapping sub-blocks. In an example, the size of each sub-block can be a predefined size that is known to (i.e., is a configuration of) the encoder and the decoder. The predefined size can be 16×16, 8×8, 4×4, or some other predefined size. In an example, the sub-block size can be derived from the size of the current block. To illustrate, k can be four (4) regardless of the size of the current block. As such, if the current block has a size of 32×32 pixels, then the sub-block size can be 16×16; and if the block size is 64×64 pixels, the sub-block size can be 32×32. In an example, the sub-block size can be the same as that of the current block. That is, the current block is divided into only one sub-block that is co-extensive with the current block itself. Said another way, the current block itself is used as the only sub-block.

In an example, the sub-block size can be derived from the compound prediction mode of the current block. To illustrate, if the compound prediction mode derives the initial motion vectors MV₀ and MV₁ from spatially or temporally neighboring blocks of the current block, then motion within the current block can be assumed to generally be consistent with that of the neighboring blocks. An example of such a compound mode is the NEAR_NEARMV mode of AV1. In such cases, a larger sub-block size may improve the compression gain because of the consistent motion. On the other hand, motion of compound modes that are signaled with one or more MVDs indicate that motion within the current block is less correlated with motion in the reference blocks. As such, smaller sub-block size may produce better prediction. An example of such a compound mode is the NEW_NEWMV mode of AV1.

In yet another example, the sub-block size can be signaled in a compressed bitstream, such as the compressed bitstream 420 of FIGS. 4 and 5. The sub-block size can be signaled in a sequence header, a frame header (i.e., the header of the current frame that include the current block), or a block header of the current block. The size of each sub-block is denoted W×H, where W denotes the width in pixels and H denotes the height in pixels.

At 904, the technique 900 determines whether there are more sub-blocks for which refined motion vectors are to be obtained. If there are no more sub-blocks, then the technique 900 terminates (not shown). If there are more sub-blocks, then the technique 900 proceeds to 906 to identify an optimal RefinedMV₀ and an optimal RefinedMV₁ for a next sub-block. The optimal RefinedMV₀ and the optimal RefinedMV₁ are obtained by first obtaining respective optimal MV offsets (i.e., ΔMV₀ and ΔMV₁).

In an example, and to reduce computational complexity, one optimal MV offset (denoted ΔMV) is used to obtain the optimal RefinedMV₀ and an optimal RefinedMV₁. The optimal RefinedMV₀ and an optimal RefinedMV₁ are then obtained using equation (1), where d₀ and d₁ are as described with respect to FIG. 8:

$$\{ \begin{matrix}{RefinedMV}_{0 , x} = {MV}_{0 , x} + Δ {MV}_{x} \\ {RefinedMV}_{0 , y} = {MV}_{0 , y} + Δ {MV}_{x} \\ {RefinedMV}_{1 , x} = {MV}_{1 , x} + Δ {MV}_{x} \times \frac{{d}_{1}}{{d}_{0}} \\ {RefinedMV}_{1 , y} = {MV}_{1 , y} + Δ {MV}_{y} \times \frac{{d}_{1}}{{d}_{0}}\end{matrix} \qquad ( 1 )$$

In an example, identifying, at 906, the optimal RefinedMV₀ and the optimal RefinedMV₁ for the next sub-block includes the steps 906_2 to 906_14. In steps 906_2 to 906_14, the technique 900 iterates, in each of the horizontal and the vertical directions, over all possible in MV offsets in a search area to identify an optimal MV offset.

An optimal MV offset (ΔMV) for a sub-block can be found (e.g., identified) by searching neighboring areas of MV₀ and MV₁. The technique 900 (i.e., the decoder or encoder, as the case may be) searches a predefined (2n+1)×(2n+1) area around the initial motion vectors and selects as the optimal MV offset (ΔMV) the MV offset that produces a best match between a first predictor P₀ and a second predictor P₁. In an example, the best match can be identified using sum of absolute values (SAD). In an example, only a subset (e.g., all) of offset motion vectors corresponding to integer pixel positions within the search area (2n+1)×(2n+1) are considered. In another example, the search can also include motion vectors at sub-pixel positions. The sub-pixel positions can be at ½, ¼, ⅛, 1/16, or some other sub-pixel precision. In an example, n can be 2. As such, the search area includes (2×2+1)×(2×2+1)=25 integer positions.

For each of the offset MVs within the search area, a similarity metric between the corresponding first predictor P₀ and second predictor P₁ is determined. In an example, and as mentioned, the sum of absolute values (SAD) can be used as the similarity metric. However, other similarity metrics are possible, such as the mean square error, Hadamard-transform based SAD, or some other suitable similarity metric. The SAD between a first predictor P₀ a second predictor P₁ can be calculated using equation (2), in which W and H are, respectively, the width and the height of the sub-block:

$$SAD = {\sum }_{i = 0}^{W - 1} {\sum }_{j = 0}^{H - 1} \vert {P}_{0} ( i , j ) - {P}_{1} ( i , j ) \vert \qquad ( 2 )$$

FIG. 10 illustrates a search area 1014 in the first reference frame and a search area 1016 in the second reference frame. For brevity, only the search area 1014 is further described since a similar description applies with respect to the search area 1016. The search area 1014 illustrates integer pixel locations in a (2n+1) (2n+1) search area, where n=2. In an example, the technique 900 can iterate over the 25 integer pixel locations. In another example, the technique 900 can additionally iterate over sub-pixel locations in increments according to a specified precision, such as ⅛^{th} or some other sub-pixel precision.

The search area 1014 is centered at the end point of the initial MV 1008. At 906_2, the technique 900 determines whether there are additional horizontal offsets to search (e.g., test, visit, etc.). If there are, then the technique 900 proceeds to 906_4; otherwise the technique 900 proceeds to 906_14. Step 906_2 may be or may implement an outer loop, which may be represented in pseudo-code as “for ΔMVx=−n to +n” and the step 906_4 may be or may implement an inner loop, which may be represented in pseudo-code as “for ΔMVy=−n to +n.”

At 906_6, refined motion vectors RefinedMV₀ and RefinedMV₁ are computed, such as using equation (1). At 906_8, a first prediction block P₀ is obtained from or using RefinedMV₀. At 906_10, a second prediction block P₁ is obtained from or using RefinedMV₁. At 906_12, a similarity metric between the first prediction block P₀ and second prediction block P₁ is computed. In an example, the similarity metric can be the SAD between the first prediction block P₀ and second prediction block P₁. From 906_12, the technique 900 proceeds back to 906_4 to move to the next vertical offset in the search area. If there are no more vertical offsets to test for a current horizontal offset selected at 906_2, then the technique 900 proceeds from 906_4 to 906_2 to select the next horizontal offset (if any).

At 906_14, an optimal RefinedMV₀ and an optimal RefinedMV₁ corresponding to the best similarity is identified. In an example, the best similarity can correspond to the minimal SAD. Referring again to FIG. 10, the illustration 1000 shows that an optimal offset 1018 (i.e., optimal ΔMV) is identified therewith resulting in a first refined MV 1020 and a second refined MV 1022.

In an example, and to reduce computational complexity, only a subset of the search points of a search area are considered. That is, only a subset of the (2n+1)×(2n+1) integer locations are searched (e.g., considered). In an example, the subset can be as shown with respect to a search area 1024 of FIG. 10. As such, the search area can include the integer pixel location at (−2, −2), (−2, 0), (−2, 2), (−1, −1), (−1, 0), (−1, 1), (0, −2), (0, −1), (0, 0), (0, 1), (0, 2), (1, −1), (1, 0), (1, 1), (2, −2), (2, 0), and (2, 2), where (0, 0) is the end point of the motion vector (i.e., the integer pixel or closest integer pixel that the initial MV 1008 points to).

In yet another example of reducing complexity, a multi-step (e.g., a two-step) search can be performed, as illustrated with respect to search area 1026 of FIG. 10. To illustrate, in a first step, an (n+1)×(n+1) search area range around the center (0, 0) is searched for an intermediate optimal MV offset. In a next step, set the center to pixel location corresponding to the intermediate optimal MV offset and perform a search again for the optimal MV offset in an (n+1)×(n+1) search window. To illustrate, In a first step, the origin is set to at a pixel location 1028 and the points in a 3×3 window (i.e., n=1) are searched for the intermediate optimal MV offset. As such, all points filled with a pattern 1030 are searched. FIG. 10 illustrates that the intermediate optimal MV offset corresponds to a location 1032. Thus, the center is now moved to the location 1032 and a 3×3 window around the new center is now searched. Thus, the pixel locations filled with a pattern 1034 are now additionally searched. FIG. 10 illustrates that the optimal MV offset corresponds to a location 1036. Locations filled with a pattern 1038 (e.g., empty circles) are not searched. A two-step search process is further illustrated with respect to the pseudo-code of Table I.

TABLE I
Identify initial MV

```
Step 1
  Set center to (0, 0)
  Search 3×3 window for intermediate optimal MV offset
  Select the point in the 3×3 window corresponding to minimal SAD
Step 2
  Set MV = initial MV + intermediate optimal MV offset
  Set center to the point selected in Step 1
  Search 3×3 window for optimal MV offset
  Select the point in the 3×3 window corresponding to minimal SAD
  Set RefinedMV = MV + optimal MV offset
```

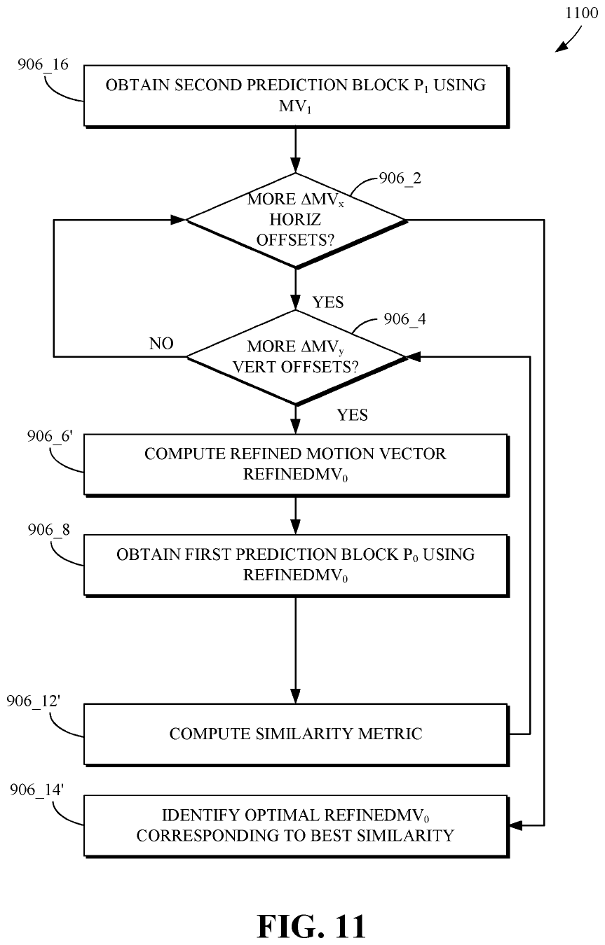

In another example of complexity reduction, an optimal offset MV can be computed for only one of the reference frames. The MV of the other reference frame can remain unchanged. FIG. 11 is an example of a technique 1100 for identifying an optimal offset MV for only one of two reference frames. The steps described with respect to the technique 1100 can be used in place of the steps 906_2 to 906_14 of FIG. 9. The technique 1100 includes many of the same steps as 906_2 to 906_14 and only differences therefrom are described.

FIG. 11 illustrates that MV₁ is kept unchanged and an optimal offset is derived only for MV₀. The technique 1100 does not include the step 906_10. Instead, the technique 1100 include a step 906_16 for obtaining a second prediction block P₁ using MV₁ outside the outer loop of step 906_2 and the inner loop of step 906_4. That is, the first prediction block P₁ is calculated once. At 906_6′, a refined motion vector RefinedMV₀ is calculated. At 906_12′ a similarity metric is computed between the second prediction block P₁ obtained at 906_16 and the first prediction block P₀ obtained at 906_8. At 906_14′, an optimal RefinedMV₀ corresponding to the best similarity is identified. When the technique 1100 is used for the step 906 of FIG. 9, the final prediction for the next subblock is generated, at 908, using the optimal RefinedMV₀ and MV₁. As can be appreciated, any of the search techniques (e.g., searching at sub-pixel locations, two-step search process, sub-set of integer locations, or a combination thereof) can be used in conjunction with the identifying an optimal offset MV for only one of two reference frames.

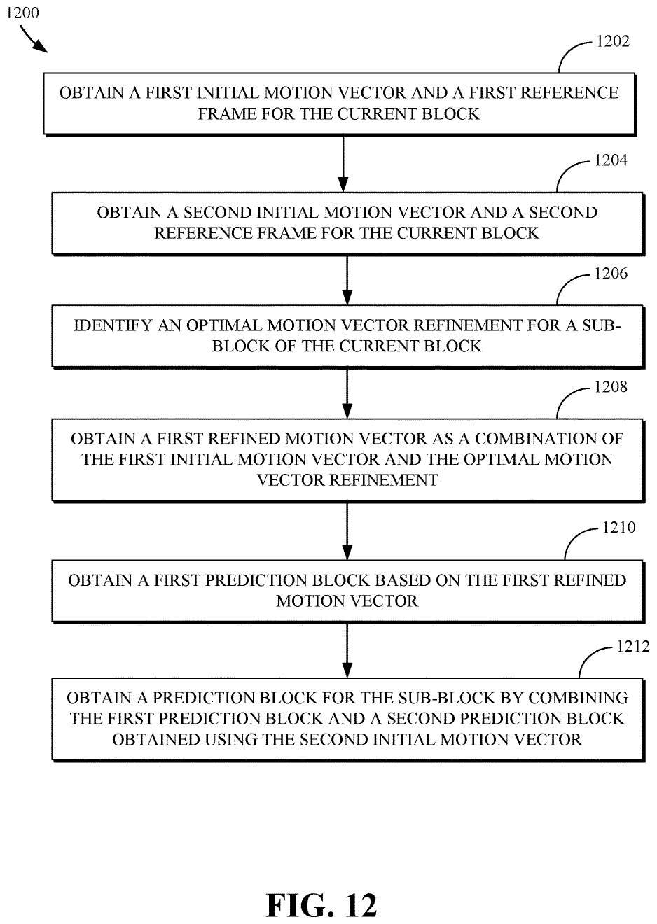

To further describe some implementations in greater detail, reference is next made to examples of techniques which may be performed for sub-block based motion vector refinement. FIG. 12 is an example of a flowchart of a technique 1200 for coding a current block using motion vector refinement. The technique 1200 can be executed using computing devices, such as the systems, hardware, software, and techniques described with respect to FIGS. 1-11.

The technique 1200 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1200. The technique 1200 may be implemented in whole or in part in the intra/inter prediction stage 508 of the decoder 500 of FIG. 5 or the intra/inter prediction stage 402 of the encoder 400 of FIG. 4. As such, when implemented by a decoder, “coding” means “decoding;” and when implemented by an encoder, “coding” means “encoding.” The technique 1200 can be implemented using specialized hardware or firmware. Multiple processors, memories, or both, may be used.

While not specifically shown in FIG. 12, the technique 1200 may code or infer that the current block is coded using a compound inter-prediction mode. As such, the current block is associated with two MVs.

At 1202, a first initial motion vector and a first reference frame are obtained for the current block. When implemented in a decoder, obtaining the first initial motion vector and the first reference frame can include decoding from a compressed bitstream, such as the compressed bitstream 420 of FIG. 5, one or more syntax elements that can be or can be used to obtain (e.g., select, infer, etc.) the first initial motion vector and the first reference frame.

When implemented by an encoder, the encoder may obtain the first initial motion vector and the first reference frame based on a rate-distortion optimization and may encode motion information (e.g., a MVD, an MV index into a list of candidate MVs) that the decoder can use to obtain the first initial motion vector and the first reference frame in a compressed bitstream. In an example, the motion information can be the inter-prediction mode that is associated with semantics that the decoder can use to obtain the first initial motion vector and the first reference frame.

At 1204, a second initial motion vector and a second reference frame are obtained for the current block, which can be similar to obtaining the first initial motion vector and the first reference frame, at 1202.

At 1206, an optimal motion vector refinement (ΔMV) is identified for a sub-block of the current block. The optimal motion vector refinement can be identified above, such as described with respect to one of FIG. 9, FIG. 10, or FIG. 11. Identifying the optimal motion vector refinement can include searching within designated areas around the initially provided motion vectors. By evaluating these areas, motion vector adjustments that most effectively reduce discrepancies between anticipated and actual video content are identified. This optimization process leverages both spatial and temporal data correlations, ensuring motion vectors are finely tuned to enhance video stream fidelity. As such, identifying of the optimal motion vector refinement can include searching within at least one search area around at least one of the first initial motion vector or the second initial motion vector to minimize a prediction error metric. The error metric can be or can be based on the SAD between the predicted video output and the actual video data within a sub-block. By minimizing this SAD value, the technique 1200 can ensure that the motion vector refinement aligns with the actual motion observed in the video, thereby achieving a more accurate prediction and ultimately improving the video compression efficiency.

At 1208, a first refined motion vector is obtained as a combination of the first initial motion vector and the optimal motion vector refinement. The first refined motion vector can be obtained using RefinedMV_{0,x}=MV_{0,x}+ΔMVₓ and RefinedMV_{0,y}=MV_{0,y}+ΔMV_{y}. In an example, the technique 1200 can further include obtaining a second refined motion vector as a combination of the second initial motion vector and the optimal motion vector refinement. The second refined motion vector can be obtained using

$${RefinedMV}_{1 , x} = {MV}_{1 , x} - Δ {MV}_{x} \times \frac{{d}_{1}}{{d}_{0}} and$$

$${RefinedMV}_{1 , y} = {MV}_{1 , y} - Δ {MV}_{y} \times \frac{{d}_{1}}{{d}_{0}} ,$$

which are as described above.

At 1210, a first prediction block is obtained based on the first refined motion vector. At 1212, a prediction block is obtained for the sub-block by combining the first prediction block and a second prediction block obtained using the second initial motion vector. In an example, the second prediction block can be a prediction block obtained using the second initial motion vector, such as described with respect to 906_16 of FIG. 9. In another example, the second prediction block can be obtained as described with respect to 906_10 of FIG. 9.

The technique 1200 can include coding a flag within a compressed bitstream indicating to use of motion vector refinement for the current block. Coding within the compressed bitstream includes encoding in the compressed bitstream at the encoder and decoding from the compressed bitstream at the decoder.

In an example, a flag (e.g., dmvd_enable_flag) may be signaled in (i.e., encoded in and decoded from) the compressed bitstream to indicate whether sub-block based motion vector refinement is to be performed for the current block. As such, if the flag is enabled (e.g., is equal to 1), then the technique 1200 is performed. The flag can be included in a sequence header, a frame header (i.e., the header of the current frame that include the current block), or a block header of the current block. In an example, a block-level flag (i.e., dmvd_enable_flag) can be signaled to indicate whether sub-block based motion vector refinement is used for that block or not.

As signaling a block-level flag can introduce overhead bits therewith impacting compression performance, the flag can be signaled conditionally to reduce the overhead. In an example, whether the dmvd_enable_flag is coded in the compressed bitstream can be based on the compound inter prediction mode. In an example, the compound inter-prediction modes supported by a coded can be categorized into separate categories and whether the flag is encoded or inferred can depend on the category of the compound inter-prediction mode of the current block. In an example, the compound inter-prediction mode can be categorized into 1 of 3 categories (i.e., Categories 0, 1, and 2). Category 0 can be characterized by or include compound inter-prediction modes that do not use optical flow motion refinement techniques. Category 1 can be characterized by or include compound inter-prediction modes that do not signal MVDs; instead, the modes of the category 1 are such that the initial motion vectors MV₀ and MV₁ are derived from one or more lists of candidate MVs. Category 2 can be characterized by or include compound inter-prediction modes that do not belong to either category 0 or category 1.

Whether the dmvd_enable_flag is signaled (i.e., is included in the compressed bitstream) can based on the category of the compound inter-prediction mode. In an example, if the compound inter-prediction mode of the current block belongs to the category 0, then the dmvd_enable_flag can be always equal to 0, automatically disabling the feature, and is not signaled in the bitstream; if the compound inter-prediction mode of the current block belongs to the category 1, then the dmvd_enable_flag is always equal to 1, automatically enabling the feature, and is not signaled in the bitstream; and if the compound inter-prediction mode of the current block belongs to the category 3, the dmvd_enable_flag can be signaled in an explicit manner to the compressed bitstream to indicate whether sub-block based motion vector refinement is to be performed for the current block.

In another example, the dmvd_enable_flag may be signaled based on the size of the current block. For example, if the size of the block exceeds a predefined threshold size, then the flag is signaled; otherwise, the flag is not signaled and is set to 0, indicating that sub-block based motion vector refinement is not to be performed for the current block. For example, if minimum(W,H)>16, then the flag dmvd_enable_flag is signaled, where W and H are, respectively, the width and height of the current block.

Accordingly, the current block can be partitioned into sub-blocks of equal size that is selected based on the size of the current block or based on a configuration parameter (rules).

In another example, the dmvd_enable_flag may be signaled based on the distances d₀ and d₁. For example, if at least one of the distance d₀ (between the current frame and the first reference frame) or d₁ (between the current frame and the second reference frame) is greater than a threshold distance (e.g., 8 frames in display order), then the dmvd_enable_flag is signaled. If the dmvd_enable_flag is not signaled, then the value of the dmvd_enable_flag can be considered to be equal to 0.

In an example, the dmvd_enable_flag can be entropy coded using a context that may be derived based the size of the current block and the compound inter-prediction mode. However, other contexts are possible.

In an example, another syntax element (refine_mode) can be coded in the compressed bitstream instead of the dmvd_enable_flag. The refine_mode syntax element can indicate the specific way that sub-block based MV refinement strategy is to be applied. In an example, the refine_mode can have one of the values 0, 1, 2, 3. A value of 0 can indicate that sub-block based MV refinement is not to be applied. A value of 1 can indicate that both of the initial motion vectors MV₀ and MV₁ are to be refined. A value of 2 can indicate that only MV₀ is to be refined but that MV₁ is to be unchanged (i.e., is not refined). A value of 3 can indicate that only MV₁ is to be refined but that MV₀ is to be unchanged (i.e., is not refined).

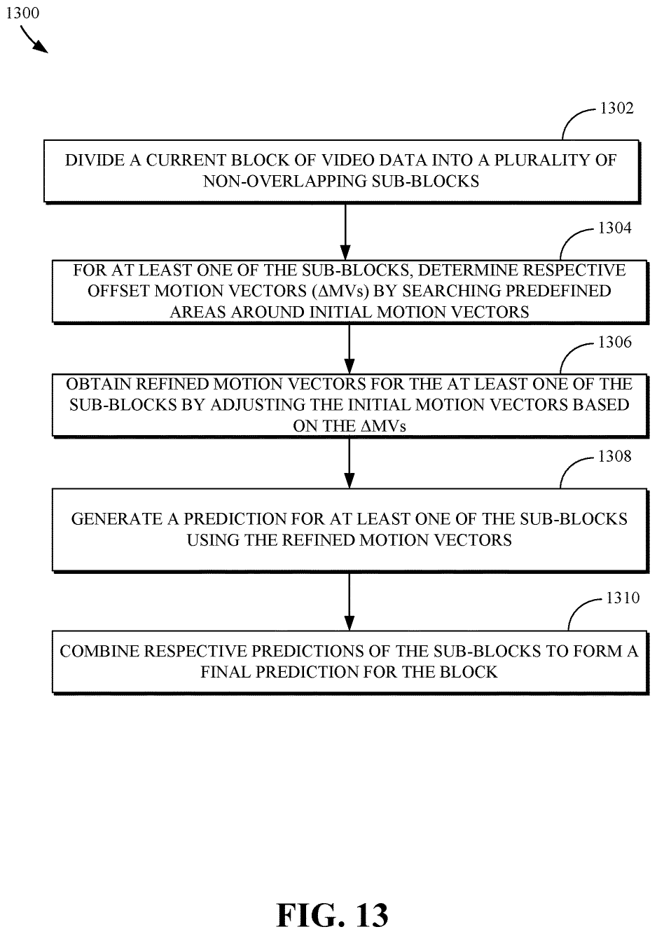

FIG. 13 is an example of a flowchart of a technique 1300 for coding a current block. The technique 1300 can be executed using computing devices, such as the systems, hardware, software, and techniques described with respect to FIGS. 1-12.

The technique 1300 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1300. The technique 1300 may be implemented in whole or in part in the intra/inter prediction stage 508 of the decoder 500 of FIG. 5 or the intra/inter prediction stage 402 of the encoder 400 of FIG. 4. As such, when implemented by a decoder, “coding” means “decoding;” and when implemented by an encoder, “coding” means “encoding.” The technique 1300 can be implemented using specialized hardware or firmware. Multiple processors, memories, or both, may be used.

At 1302, a current block of video data is divided into a plurality of non-overlapping sub-blocks. The current block of video data can be coded using a compound mode, and the initial motion vectors include respective motion vectors for two reference frames. As described herein, in an example, the size of the sub-blocks can be determined based on the size of the current block; and in another example, the size of the sub-blocks can be determined based on a coding mode of the current block. In an example, a flag can be signaled within a compressed bitstream indicating whether sub-block based motion vector refinement is applied. The flag may be signaled at at least one of a sequence header, frame header, or the current block level.

At 1304, for at least one of the sub-blocks, respective offset motion vectors (ΔMVs) are determined by searching predefined areas around initial motion vectors associated with the current block. The predefined areas include integer and sub-pixel positions. The respective offset motion vectors (ΔMVs) can be determined based on a similarity metric between predicted values of at least one of the sub-blocks and corresponding values in a reference frame.

At 1306, refined motion vectors are obtained for at the least one of the sub-blocks by adjusting the initial motion vectors based on the respective offset motion vectors (ΔMVs). At 1308, a prediction is generated for at least one of the sub-blocks using the refined motion vectors. At 1310, respective predictions of the sub-blocks are combined to form a final prediction for the block.

For simplicity of explanation, the techniques described herein, such as the techniques 900, 1100, 1200, and 1300 of FIGS. 9, 11, 12, and 13, respectively, are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for coding a current block using motion vector refinement, comprising:
obtaining a first initial motion vector and a first reference frame for the current block;
obtaining a second initial motion vector and a second reference frame for the current block;
identifying an optimal motion vector refinement for a sub-block of the current block;
obtaining a first refined motion vector as a combination of the first initial motion vector and the optimal motion vector refinement;
obtaining a first prediction block based on the first refined motion vector; and
obtaining a prediction block for the sub-block by combining the first prediction block and a second prediction block obtained using the second initial motion vector.

2. The method of claim 1, further comprising:
obtaining a second refined motion vector as a combination of the second initial motion vector and the optimal motion vector refinement; and
obtaining the second prediction block based on the second refined motion vector,
wherein the second prediction block is obtained based on the second refined motion vector.

3. The method of claim 1, wherein identifying of the optimal motion vector refinement comprises:
searching within at least one search area around at least one of the first initial motion vector or the second initial motion vector to minimize a prediction error metric.

4. The method of claim 3, wherein the optimal motion vector refinement is identified based on a sum of absolute differences (SAD) calculation between predicted and actual pixel values within the sub-block.

5. The method of claim 1, further comprising:
coding a flag within a compressed bitstream indicating whether to use the motion vector refinement.

6. The method of claim 5, wherein the flag is conditionally coded based on a compound inter-prediction mode of the current block, with specific modes automatically enabling or disabling the motion vector refinement without explicit signaling of the flag.

7. The method of claim 5, wherein the flag is enabled if a size of the current block exceeds a predetermined threshold.

8. The method of claim 5, wherein the flag is coded based on respective distances between a current frame that includes the current block and the first reference frame and the second reference frame.

9. The method of claim 1, further comprising:
coding within a compressed bitstream a syntax element specifying a motion vector refinement strategy indicating which of the first initial motion vector and the second initial motion vector are refined.

10. The method of claim 1, wherein combining the first prediction block and the second prediction block comprises using a weighted average with weights determined based on respective temporal distances of the first reference frame and the second reference frame from a current frame that includes the current block.

11. The method of claim 1, further comprising:
partitioning the current block into sub-blocks including the sub-block, wherein the sub-blocks are of equal size that is selected based on a size of the current block or based on a configuration parameter.

12. A method, comprising:
dividing a current block of video data into a plurality of non-overlapping sub-blocks;
for at least one of the sub-blocks, determining respective offset motion vectors (ΔMVs) by searching predefined areas around initial motion vectors associated with the current block;
obtaining refined motion vectors for at the least one of the sub-blocks by adjusting the initial motion vectors based on the respective offset motion vectors (ΔMVs);
generating a prediction for at least one of the sub-blocks using the refined motion vectors; and
combining respective predictions of the sub-blocks to form a final prediction for the current block.

13. The method of claim 12, wherein the predefined areas include integer and sub-pixel positions.

14. The method of claim 12, wherein the respective offset motion vectors (ΔMVs) are determined based on a similarity metric between predicted values of at least one of the sub-blocks and corresponding values in a reference frame.

15. The method of claim 12, wherein the current block is coded using a compound mode, and the initial motion vectors include respective motion vectors for two reference frames.

16. The method of claim 12, further comprising:
signaling a flag within a compressed bitstream indicating whether sub-block based motion vector refinement is applied.

17. The method of claim 16, wherein the flag is signaled at at least one of a sequence header, frame header, or current block level.

18. The method of claim 12, wherein a size of the sub-blocks is determined based on a size of the current block.

19. The method of claim 12, wherein a size of the sub-blocks is determined based on a coding mode of the current block.

20. A method, comprising:
receiving a compressed bitstream that includes initial motion vectors for a current block of video data;
partitioning the current block into a plurality of non-overlapping sub-blocks;
for each of the sub-blocks, identifying respective optimal offset motion vectors (ΔMVs) by evaluating a search area around at least one of the initial motion vectors;
adjusting the initial motion vectors based on the optimal offset motion vectors MV to obtain refined motion vectors; and
decoding the sub-blocks based on the refined motion vectors.

21. The method of claim 20, wherein the search area is centered on the at least one of the initial motion vectors and includes a predefined range in a horizontal direction and a vertical direction.

22.-26. (canceled)
